(19) United States
(12) Patent Application Publication
(10) Pub. No.: US 2018/0117954 A1
(43) Pub. Date: May 3, 2018

(54) TEMPORARY TATTOO LABEL AND SYSTEM

(71) Applicant: Diana Brown, Ankeny, IA (US)

(72) Inventor: Diana Brown, Ankeny, IA (US)

(21) Appl. No.: 15/340,154

(22) Filed: Nov. 1, 2016

(51) Int. Cl. B44C 1/10

(52) U.S. Cl. CPC B44C 1/105

(57) ABSTRACT

A system for a temporary tattoo that includes: a label; a transfer film integrated within the label, wherein the transfer film is adapted for removal from the label; and an insignia on the transfer film, where the insignia is adapted for transfer onto a user's skin. The insignia relates to a marketing label or logo associated with the label.

### BACKGROUND OF THE INVENTION

### Field of Invention

The present invention relates to a system for application of a temporary tattoo using a label.

### Description of Related Art

Tattoos are a common form of body modification that involves the impregnation of ink into the skin of a subject. Tattooists inject the ink into the skin and it forms a permanent ink impression into the skin pigment. Various sorts of permanent tattoos are acquired by individuals and typically take a significant amount of time and effort to achieve the finished work. As a novelty item certain tattoos may be applied temporarily through the use of an imprint impression on the top of the skin. Usually transfer sheets are used to transfer such tattoos by moistening the film and then allowing the temporary ink to transfer onto the skin of the user. Many times individuals get tattoo impressions of their favorite brand or beverages. It would be advantageous to feature a label equipped with a film transfer tattoo so that the users can apply temporary tattoos as desired as a novelty item.

### SUMMARY OF THE INVENTION

The present invention relates to a system for a temporary tattoo that includes: a label; a transfer film integrated within the label, wherein the transfer film is adapted for removal from the label; and an insignia on the transfer film, where the insignia is adapted for transfer onto a user's skin. The insignia relates to a marketing label or logo associated with the label.

### BRIEF DESCRIPTION OF DRAWINGS

FIG. 1 shows three embodiments of a label that includes transfer film for application of a tattoo.

### DETAILED DESCRIPTION

The present invention relates to a system that is used to apply a temporary tattoo onto a user. This system involves a traditional label that may be placed on a bottle or item of manufacture, where a transfer film is integrated within the label. The insignia on the transfer film may be related to a label, brand or trademark used by the product.

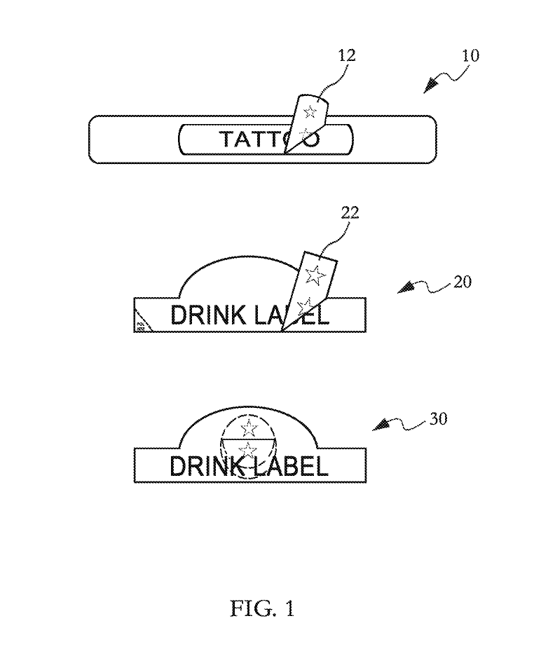

Ideally as shown in FIG. 1, a series of labels 10, 20, 30 are shown. These labels 10, 20, 30 include a transfer sheet such as transfer Film 12 of Label 10 and transfer Film 22 of Label 20.

This transfer film is easily removed, pealed from the label and then used to apply a temporary tattoo onto the skin if the user. An insignia in integrated into the transfer film and is removed from the label to expose for application onto the skin of the user. The transfer film is placed face down onto the skin with the backing then moistened to allow the transfer of the ink onto the skin of the user. This imprints a temporary tattoo onto the user's skin as a novelty piece. The instant invention has been shown and described in what it considers to be the most practical and preferred embodiments. It is recognized, however, that departures may be made there from within the scope of the invention and that obvious modifications will occur to a person skilled in the art.

What is claimed is:

1. A system for a temporary tattoo comprising;
a label;
a transfer film integrated within the label, wherein the transfer film is adapted for removal from the label; and
an insignia on the transfer film, where the insignia is adapted for transfer onto a user's skin.

2. The system according to claim 1, wherein the insignia relates to a marketing label or logo associated with the label.
